(19) United States
(12) Patent Application Publication
(10) Pub. No.: US 2023/0138088 A1
(43) Pub. Date: May 4, 2023

(54) Variable rate precision fertilizer applicator

(71) Applicant: Northeast Institute of Geography and Agroecology, Chinese Academy of Sciences, Changchun (CN)

(72) Inventor: Lingxue Yu, Changchun (CN)

(73) Assignee: Northeast Institute of Geography and Agroecology, Chinese Academy of Sciences, Changchun (CN)

(21) Appl. No.: 17/984,255

(22) Filed: Nov. 10, 2022

(30) Foreign Application Priority Data
Feb. 14, 2022 (CN) 202210131841.0

(51) Int. Cl. A01C 23/04; A01C 23/00

(52) U.S. Cl. CPC A01C 23/04; A01C 23/008; A01C 23/007

(57) ABSTRACT

The present invention provides a variable rate precision fertilizer applicator, comprising a connecting plate, a fertilizer bin and a fertilization mechanism. A plurality of connecting belts are fixed on the connecting plate; the connecting plate is connected with a fertilization unmanned aerial vehicle (UAV) through the connecting belts; a connecting column is fixed on a bottom surface of the connecting plate, and the connecting plate is fixedly connected with the fertilizer bin through the connecting column; a storage bin is separated into a solid bin and a liquid bin through a partition plate; a release bin is arranged on one side of the storage bin; the spiral feeding cylinder is installed in the solid bin; a liquid pump is installed in the liquid bin; the discharge port is installed in the release bin; the fertilization mechanism is installed at the bottom side of the fertilizer bin.

### TECHNICAL FIELD

The present invention belongs to the technical field of supporting fertilization equipment of unmanned aerial vehicles (UAVs), and particularly relates to a variable rate precision fertilizer applicator.

### BACKGROUND

In the black soil region of northeast China, excessive fertilization and pesticide application cause soil compaction and degradation of cultivated land quality, and threaten national food security. It is urgent to protect cultivated land resources and improve cultivated land capacity and crop quality. The use of precision management and partitioning to guide variable rate fertilization and pesticide application allows for purposeful management according to soil and crop differences. Reducing the use amount of fertilizers and pesticides while increasing grain yield or ensuring no reduction in yield is an agricultural production measure in urgent need of development.

The use amount of fertilizers in China ranks the first in the world, but the utilization rate is low. Extensive fertilization not only increases the cost of cultivation, but also brings many adverse effects on the ecological environment. However, the existing precision fertilization is mostly carried out by means of ground-type variable rate fertilization agricultural machinery. With the development of UAVs and their application in the field of agriculture, it is imperative to develop UAV-based fertilization supporting equipment.

### SUMMARY

A technical problem to be solved by the present invention is to provide a variable rate precision fertilizer applicator with respect to the defects of the prior art, to solve problems proposed in the above background.

To solve the above technical problem, the present invention adopts a technical solution: a variable rate precision fertilizer applicator comprises a connecting plate, a fertilizer bin and a fertilization mechanism; a plurality of connecting belts are fixed on the connecting plate; and the connecting plate is connected with a fertilization UAV through the connecting belts;

A connecting column is fixed on a bottom surface of the connecting plate, and the connecting plate is fixedly connected with the fertilizer bin through the connecting column;

The fertilizer bin comprises a storage bin, a release bin, a spiral feeding cylinder, a liquid pump and a discharge port; the storage bin is separated into a solid bin and a liquid bin through a partition plate; the release bin is arranged on one side of the storage bin; the spiral feeding cylinder is installed in the solid bin; the liquid pump is installed in the liquid bin; the discharge port is installed in the release bin; and the spiral feeding cylinder and an outlet of the liquid pump are respectively communicated with the discharge port through a communicating pipe;

The fertilization mechanism is installed at the bottom side of the fertilizer bin; a fertilization head is installed in the fertilization mechanism; and the fertilization head is communicated with the discharge port through a flexible cylinder.

Further, the fertilization mechanism comprises a first installing plate, a second installing plate, first hydraulic rods, second hydraulic rods and a fertilization head; one side of a top surface of the first installing plate is rotatably connected with two connecting rods; the top ends of the two connecting rods are respectively rotatably connected with the bottom side of the fertilizer bin; the other side of the top surface of the first installing plate is rotatably connected with two first hydraulic rods; and the top ends of the two first hydraulic rods are respectively rotatably connected with the bottom side of the fertilizer bin;

The bottom side of the first installing plate is rotatably connected with the second installing plate; the other side of the second installing plate is rotatably connected with two second hydraulic rods; the middle sections of the second hydraulic rods are rotatably connected to the side end of the first installing plate; the fertilization head is in threaded connection with the bottom side of the second installing plate; the top surface of the second installing plate is also fixed with the flexible cylinder communicated with the fertilization head; and the flexible cylinder penetrates through the first installing plate and is fixed on the bottom surface of the discharge port of the fertilizer bin.

Further, a gap of at least 5 cm is arranged between a surface where the first installing plate is in a horizontal state and a surface where the second installing plate is in a horizontal state.

Further, the flexible cylinder is specifically a tubular structure with a large top and small bottom.

Further, the connecting rods are respectively movably connected with the fertilizer bin and the first installing plate through a spherical seat; the bottom ends of telescopic rods of the first hydraulic rods are movably connected with the first installing plate through a hinging seat; and the bottom ends of telescopic rods of the second hydraulic rods are also movably connected with the second installing plate through the hinging seat.

Further, the bottom side of the solid bin is rotatably connected with a bottom plate; the other side of the bottom plate is rotatably connected with two electric push rods; the top ends of the electric push rods are rotatably connected to the inner top side of the solid bin; one side of the bottom plate close to the electric push rods is also fixed with a flexible barrier; the bottom side of the solid bin is fixed with a feeding chute; and the bottom side of the spiral feeding cylinder is communicated in the feeding chute.

Further, the storage bin is provided with charging ports at the top ends of the solid bin and the liquid bin.

Further, the outer side of the fertilizer bin is provided with a plurality of transparent windows.

Further, the connecting plate is pasted with a flexible pad in the inner region of the connecting belts.

Further, two horizontal monitors are fixed on the bottom surface of the fertilization mechanism.

Compared with the prior art, the present invention has the following advantages:

In the present invention, by installing the fertilization mechanism on the bottom side of the fertilizer bin, the first installing plate of the fertilization mechanism is connected to the bottom side of the fertilizer bin through the two connecting rods and the two first hydraulic rods; the levelness of the first installing plate in a tangential direction can be adjusted through the two first hydraulic rods; the bottom side of the first installing plate is rotatably connected with the second installing plate; the other side of the second installing plate is rotatably connected with two second hydraulic rods; the levelness of the second installing plate in a normal direction can be adjusted through two second hydraulic rods; thus, when the UAV is used for fertilization, the fertilizer is loaded into the solid bin and the liquid bin according to the type of solid and liquid, and then delivered to the discharge port for fertilization respectively through the spiral feeding cylinder and the liquid pump according to the type; the levelness of the fertilization head can be measured in real time through the horizontal monitors in the fertilization process; when the tilt of the fertilization head in one direction exceeds a preset value, the controller is used to control the two first hydraulic rods and the two second hydraulic rods respectively to adjust the levelness of the second installing plate in different directions, to ensure that the fertilization head is kept on the horizontal plane in the fertilization process, so as to ensure that the fertilization head can be evenly distributed horizontally during fertilization, thereby ensuring the accuracy and uniformity of the fertilization process, improving the use efficiency of the fertilizer, avoiding the phenomenon of soil compaction due to uneven fertilization and realizing economy and practicability.

### DESCRIPTION OF DRAWINGS

FIG. 1 is an overall structural schematic diagram of the present invention.

FIG. 2 is an internal structural sectional view of a solid bin of the present invention.

FIG. 3 is an enlarged view of a fertilization mechanism of the present invention.

FIG. 4 is an internal structural top view of a fertilizer bin of the present invention.

1—connecting plate; 11—connecting belt; 12—flexible pad; 13—connecting column; 2—fertilizer bin; 21—storage bin; 22—solid bin; 221—bottom plate; 222—electric push rod; 223—flexible barrier; 224—feeding chute; 23—liquid bin; 24—release bin; 25—spiral feeding cylinder; 26—liquid pump; 27—discharge port; 28—transparent window; 3—fertilization mechanism; 31—first installing plate; 32—second installing plate; 33—connecting rod; 34—first hydraulic rod; 35—hinge; 36—second hydraulic rod; 37—flexible cylinder; 38—fertilization head.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

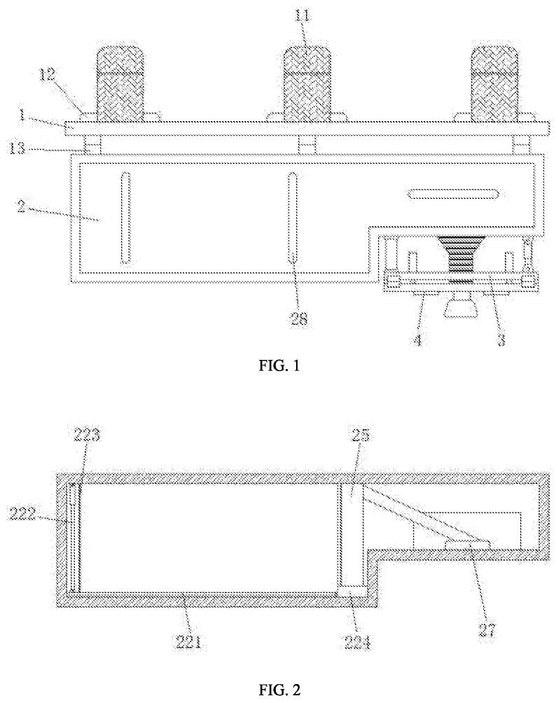

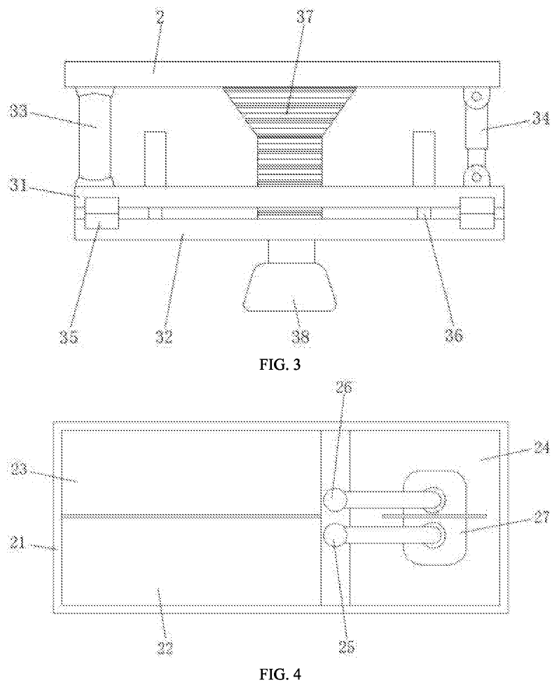

As shown in FIGS. 1-4, the present invention provides a technical solution: a variable rate precision fertilizer applicator comprises a connecting plate 1, a fertilizer bin 2 and a fertilization mechanism 3; a plurality of connecting belts 11 are fixed on the connecting plate 1; the connecting plate 1 is pasted with a flexible pad 12 in an inner region of the connecting belts 11; and the connecting plate 1 is connected with a fertilization unmanned aerial vehicle (UAV) through the connecting belts 11.

A connecting column 13 is fixed on a bottom surface of the connecting plate 1, and the connecting plate 1 is fixedly connected with the fertilizer bin 2 through the connecting column 13.

The fertilizer bin 2 comprises a storage bin 21, a release bin 24, a spiral feeding cylinder 25, a liquid pump 26 and a discharge port 27; the storage bin 21 is separated into a solid bin 22 and a liquid bin 23 through a partition plate; the release bin 24 is arranged on one side of the storage bin 21; the spiral feeding cylinder 25 is installed in the solid bin 22; the bottom side of the solid bin 22 is rotatably connected with a bottom plate 221; the other side of the bottom plate 221 is rotatably connected with two electric push rods 222; the top ends of the electric push rods 222 are rotatably connected to the inner top side of the solid bin 22; one side of the bottom plate 221 close to the electric push rods 222 is also fixed with a flexible barrier 223; the bottom side of the solid bin 22 is fixed with a feeding chute 224; and the bottom side of the spiral feeding cylinder 25 is communicated in the feeding chute 224; the electric push rods 222 can drive one side of the bottom plate 221 to move up, so that the solid bin 22 can tilt into the feeding chute 224 when the material in the solid bin is less, so as to ensure that the solid fertilizer in the solid bin 22 can be completely released, to avoid the effect that part of the fertilizer cannot be released in time in the fertilization process of the UAV.

The liquid pump 26 is installed in the liquid bin 23; the discharge port 27 is installed in the release bin 24; and the spiral feeding cylinder 25 and an outlet of the liquid pump 26 are respectively communicated with the discharge port 27 through a communicating pipe.

The storage bin 21 is provided with charging ports at the top ends of the solid bin 22 and the liquid bin 23. The charging ports can add different types of fertilizers to the solid bin 22 and the liquid bin 23 respectively.

The outer side of the fertilizer bin 2 is provided with a plurality of transparent windows 28. The transparent windows 28 can be used for observing the inside of the fertilizer bin 2, which is convenient for timely cleaning and sorting.

The fertilization mechanism 3 is installed on the bottom side of the fertilizer bin 2. The fertilization mechanism 3 comprises a first installing plate 31, a second installing plate 32, first hydraulic rods 34, second hydraulic rods 36 and a fertilization head 38; one side of a top surface of the first installing plate 31 is rotatably connected with two connecting rods 33; the top ends of the two connecting rods 33 are respectively rotatably connected with the bottom side of the fertilizer bin 2; the other side of the top surface of the first installing plate 31 is rotatably connected with two first hydraulic rods 34; and the top ends of the two first hydraulic rods 34 are respectively rotatably connected with the bottom side of the fertilizer bin 2. The levelness of the first installing plate 31 in the tangential direction can be adjusted by the two first hydraulic rods 34, so that the levelness of the second installing plate 32 in the tangential direction can also be adjusted.

The bottom side of the first installing plate 31 is rotatably connected with the second installing plate 32; the other side of the second installing plate 32 is rotatably connected with two second hydraulic rods 36; the middle sections of the second hydraulic rods 36 are rotatably connected to the side end of the first installing plate 31; and the fertilization head 38 is in threaded connection with the bottom side of the second installing plate 32. The two second hydraulic rods 36 can adjust the levelness of the second installing plate 32 in the normal direction so that the levelness of the second installing plate 32 in different directions can be adjusted through the two first hydraulic rods 34 and the two second hydraulic rods 36, to ensure that the fertilization head 38 is kept on the horizontal plane in the fertilization process, so as to ensure that the phenomenon of local uneven fertilization may not occur due to tilt after fertilization.

The top surface of the second installing plate 32 is also fixed with the flexible cylinder 37 communicated with the fertilization head 38; the fertilization head 38 can be replaced according to different fertilization types to ensure the implementation of different fertilizers; and the flexible cylinder 37 penetrates through the first installing plate 31 and is fixed on the bottom surface of the discharge port 27 of the fertilizer bin 2.

For the convenience of increasing the adjustment range of the levelness of the second installing plate 31 in the normal direction, a gap of at least 5 cm is arranged between a surface where the first installing plate 31 is in a horizontal state and a surface where the second installing plate 32 is in a horizontal state.

To facilitate the conveyance of the fertilizers, the flexible cylinder 37 is specifically a tubular structure with large top and small bottom.

To facilitate the adjustment and avoid deviation in the adjustment process, which may result in the phenomenon of unstable connection of the fertilization head 38, the connecting rods 33 are respectively movably connected with the fertilizer bin 2 and the first installing plate 31 through a spherical seat; the bottom ends of telescopic rods of the first hydraulic rods 34 are movably connected with the first installing plate 31 through a hinging seat; and the bottom ends of telescopic rods of the second hydraulic rods 36 are also movably connected with the second installing plate 32 through the hinging seat.

Two horizontal monitors 4 are fixed on the bottom surface of the fertilization mechanism 3. Specifically, the horizontal monitors 4 are installed at both ends of the bottom side of the second installing plate 32. The horizontal monitors 4 can be used for measuring the levelness of the second installing plate 32 in real time, i.e., the levelness of the fertilization head 38, to ensure the uniformity and stability of fertilization.

In conclusion, when the UAV is used for fertilization, the fertilizer is loaded into the solid bin 22 and the liquid bin 23 according to the type of solid and liquid, and then delivered to the discharge port 27 for fertilization respectively through the spiral feeding cylinder 25 and the liquid pump 26 according to the type.

The levelness of the fertilization head 38 can be measured in real time through the horizontal monitors 4 in the fertilization process; when the tilt of the fertilization head 38 in one direction exceeds a preset value, the controller is used to control the two first hydraulic rods 34 and the two second hydraulic rods 36 respectively to adjust the levelness of the second installing plate 32 in different directions, to ensure that the fertilization head 38 is kept on the horizontal plane in the fertilization process, so as to ensure that the fertilization head 38 can be evenly distributed horizontally during fertilization, thereby ensuring the accuracy and uniformity of the fertilization process, improving the use efficiency of the fertilizer, avoiding the phenomenon of soil compaction due to uneven fertilization and realizing economy and practicability.

It should be noted that herein, relationship terms of first, second and the like herein are just used for differentiating one entity or operation from the other entity or operation, and do not necessarily require or imply any practical relationship or sequence between the entities or operations. Moreover, terms of “comprise”, “include” or any other variant are intended to cover non-exclusive inclusion, so that a process, a method, an article or a device which includes a series of elements not only includes such elements, but also includes other elements not listed clearly or also includes inherent elements in the process, the method, the article or the device.

Although the embodiments of the present invention have been shown and described, it will be appreciated that various variations, amendments, replacements and modifications can be made by those ordinary skilled in the art without departing from the principle and spirit of the present invention, and the scope of the present invention is limited by the appended claims and the equivalents thereof.

1. A variable rate precision fertilizer applicator, comprising a connecting plate (1), a fertilizer bin (2) and a fertilization mechanism (3), wherein a plurality of connecting belts (11) are fixed on the connecting plate (1); and the connecting plate (1) is connected with a fertilization unmanned aerial vehicle (UAV) through the connecting belts (11);
a connecting column (13) is fixed on a bottom surface of the connecting plate (1), and the connecting plate (1) is fixedly connected with the fertilizer bin (2) through the connecting column (13);
the fertilizer bin (2) comprises a storage bin (21), a release bin (24), a spiral feeding cylinder (25), a liquid pump (26) and a discharge port (27); the storage bin (21) is separated into a solid bin (22) and a liquid bin (23) through a partition plate; the release bin (24) is arranged on one side of the storage bin (21); the spiral feeding cylinder (25) is installed in the solid bin (22); the liquid pump (26) is installed in the liquid bin (23); the discharge port (27) is installed in the release bin (24); and the spiral feeding cylinder (25) and an outlet of the liquid pump (26) are respectively communicated with the discharge port (27) through a communicating pipe;
the fertilization mechanism (3) is installed at the bottom side of the fertilizer bin (2); a fertilization head (38) is installed in the fertilization mechanism (3); and the fertilization head (38) is communicated with the discharge port (27) through a flexible cylinder (37).

2. The variable rate precision fertilizer applicator according to claim 1, wherein the fertilization mechanism (3) comprises a first installing plate (31), a second installing plate (32), first hydraulic rods (34), second hydraulic rods (36) and a fertilization head (38); one side of a top surface of the first installing plate (31) is rotatably connected with two connecting rods (33); the top ends of the two connecting rods (33) are respectively rotatably connected with the bottom side of the fertilizer bin (2); the other side of the top surface of the first installing plate (31) is rotatably connected with two first hydraulic rods (34); and the top ends of the two first hydraulic rods (34) are respectively rotatably connected with the bottom side of the fertilizer bin (2);
the bottom side of the first installing plate (31) is rotatably connected with the second installing plate (32); the other side of the second installing plate (32) is rotatably connected with two second hydraulic rods (36); the middle sections of the second hydraulic rods (36) are rotatably connected to the side end of the first installing plate (31); the fertilization head (38) is in threaded connection with the bottom side of the second installing plate (32); the top surface of the second installing plate (32) is also fixed with the flexible cylinder (37) communicated with the fertilization head (38); and the flexible cylinder (37) penetrates through the first installing plate (31) and is fixed on the bottom surface of the discharge port (27) of the fertilizer bin (2).

3. The variable rate precision fertilizer applicator according to claim 2, wherein a gap of at least 5 cm is arranged between a surface where the first installing plate (31) is in a horizontal state and a surface where the second installing plate (32) is in a horizontal state.

4. The variable rate precision fertilizer applicator according to claim 2, wherein the flexible cylinder (37) is specifically a tubular structure with large top and small bottom.

5. The variable rate precision fertilizer applicator according to claim 2, wherein the connecting rods (33) are respectively movably connected with the fertilizer bin (2) and the first installing plate (31) through a spherical seat; the bottom ends of telescopic rods of the first hydraulic rods (34) are movably connected with the first installing plate (31) through a hinging seat; and the bottom ends of telescopic rods of the second hydraulic rods (36) are also movably connected with the second installing plate (32) through the hinging seat.

6. The variable rate precision fertilizer applicator according to claim 1, wherein the bottom side of the solid bin (22) is rotatably connected with a bottom plate (221); the other side of the bottom plate (221) is rotatably connected with two electric push rods (222); the top ends of the electric push rods (222) are rotatably connected to the inner top side of the solid bin (22); one side of the bottom plate (221) close to the electric push rods (222) is also fixed with a flexible barrier (223); the bottom side of the solid bin (22) is fixed with a feeding chute (224); and the bottom side of the spiral feeding cylinder (25) is communicated in the feeding chute (224).

7. The variable rate precision fertilizer applicator according to claim 1, wherein the storage bin (21) is provided with charging ports at the top ends of the solid bin (22) and the liquid bin (23).

8. The variable rate precision fertilizer applicator according to claim 1, wherein the outer side of the fertilizer bin (2) is provided with a plurality of transparent windows (28).

9. The variable rate precision fertilizer applicator according to claim 1, wherein the connecting plate (1) is pasted with a flexible pad (12) in an inner region of the connecting belts (11).

10. The variable rate precision fertilizer applicator according to claim 1, wherein two horizontal monitors (4) are fixed on the bottom surface of the fertilization mechanism (3).
